(19) United States
(12) Patent Application Publication
(10) Pub. No.: US 2011/0313813 A1
(43) Pub. Date: Dec. 22, 2011

(54) METHOD AND SYSTEM FOR ESTIMATING BASE SALES VOLUME OF A PRODUCT

(76) Inventors: Antony Arokia Durai Raj Kolandaiswamy, Pollachi (IN); Kanagasabapathi Balasubramanian, Surampatti (IN)

(21) Appl. No.: 12/860,277

(22) Filed: Aug. 20, 2010

(30) Foreign Application Priority Data
Jun. 18, 2010 (IN) 1699/CHE/2010

(51) Int. Cl. G06Q 10/00; G06F 17/30; G06Q 30/00

(52) U.S. Cl. 705/7.31; 707/692; 707/E17.005

(57) ABSTRACT

A method and a system for estimating a base sales volume of a product are provided. The method includes receiving sales data of the product from one or more sales data sources. Further, the method includes identifying a plurality of independent variables from the received sales data and substituting them in a regression model to calculate a total sales volume of the product. Furthermore, the method includes modifying one or more independent variables of the plurality of independent variables in the regression model to obtain the base sales volume of the product. The base sales volume of the product is the same as the calculated total sales volume when the base sales volume obtained after modifying the one or more independent variables is either negative or greater than the total sales volume.

### FIELD OF THE INVENTION

The present invention relates, generally, to estimating base sales volume of a product and, more specifically, to estimating base sales volume of a product using a multivariate regression model.

### BACKGROUND

Nowadays, organizations conduct different promotional activities to promote their products among consumers. Examples of such promotional activities could be, but are not limited to, advertisements of a particular product on television, display of product brochure or marketing material on a store, and seasonal discounts. Typically, organizations invest a large number of resources and significant capital on running these promotional activities. It therefore becomes imperative for an organization to determine the effectiveness of each such promotional activity conducted. This determination helps organizations to decide if it makes business sense to continue with a particular promotional activity.

Typically, effectiveness of a promotional activity related to a particular product is estimated to determine the sales of the product through the promotional activity. One of the conventional methods of doing this is by estimating the sales of the product that might have happened without any promotional activity (termed as “base sales volume” of the product) and subtracting it from the total sales of the product.

Conventionally, organizations identify “spikes” in sales data curve caused due to seasonality, holiday event, etc., and then smooth the curve to estimate the base sales volume of the product. This method is computationally tedious and requires complex algorithms and advanced computing systems.

The other known method is the “intercept” method based on a regression model to calculate sales assuming no promotional activity. In this method, the base sales curve is extrapolated and the “intercept” of the curve with an axis showing sales with zero promotional activity is used to estimate the base sales volume. The limitation of this method is that it might result in a negative base sales volume which is practically not possible. Thus, the base sales volume determined by this method cannot be used to get an accurate picture of the effectiveness of a particular promotional activity.

A few other methods to estimate base sales volume are present in the art, but all these have one or more limitations. For example, in one of the methods, to estimate base sales volume of a product, sales data of the product during a “non-promotional period” is not taken into account. As an example, a certain promotional activity is run for six months and the promotional activity is stopped for another six months; this method does not make use of sales data figures corresponding to the six months when no promotional activity was run. This leads to an inaccurate estimation of base sales volume of a product.

In another method for estimating base sales volume, at least few data points are always required corresponding to non-promotional period. Thus, this method does not work when no data is available for a non-promotional period.

In light of this, a method and system is required for estimating base sales volume of a product which overcomes the limitations of conventional methods mentioned above.

### SUMMARY

According to an embodiment of the present invention, a method for estimating a base sales volume of a product of an organization involved in one or more promotional activities is provided. The base sales volume of the product corresponds to sales of the product by non-promotional activities. The method includes receiving sales data of the product from one or more sales data sources. The data sources can be, for example, AC Nielsen® or Information Resource Inc® (IRI).

The method includes identifying a plurality of independent variables from the received sales data. The plurality of independent variables corresponds to at least one of sales through the one or more promotional activities and the average non-promotional price of the product. The method also includes substituting the plurality of independent variables in a regression model to calculate the total sales volume of the product.

The method includes modifying one or more independent variables of the plurality of independent variables in the regression model to obtain the base sales volume of the product. The base sales volume of the product is same as the calculated total sales volume when the base sales volume obtained after modifying the one or more independent variables is either negative or greater than the total sales volume.

According to another embodiment of the present invention, a base sales volume estimator for estimating the base sales volume of a product of an organization that uses one or more promotional activities is provided. The base sales volume of the product corresponds to sales of the product by non-promotional activities. The base sales volume estimator includes a sales data receiver for receiving sales data of the product from one or more sales data sources. Further, the base sales volume estimator includes an independent variable identifier for identifying a plurality of independent variables from the received sales data. The plurality of independent variables corresponds to at least one of sales through the one or more promotional activities and the average non-promotional price of the product.

The base sales volume estimator further includes a total sales volume calculator for substituting the plurality of independent variables in a regression model to calculate a total sales volume of the product. The base sales volume estimator also includes a base sales volume calculator for modifying one or more independent variables of the plurality of independent variables in the regression model to obtain the base sales volume of the product. The base sales volume of the product is same as the calculated total sales volume when the base sales volume obtained after modifying the one or more independent variables is either negative or greater than the total sales volume.

According to yet another embodiment of the present invention, a computer program product for use with a computer is provided. The computer program product includes a computer-usable medium having a computer-readable program code for estimating the base sales volume of a product of an organization that uses one or more promotional activities for the product. The base sales volume of the product corresponds to sales of the product by non-promotional activities. The computer program code includes program instructions for receiving sales data of the product from one or more sales data sources such as AC Nielsen or IRI. Further, the computer program code includes program instructions for identifying a plurality of independent variables from the received sales data. The plurality of independent variables corresponds to at least one of sales through the one or more promotional activities and an average non-promotional price of the product.

The computer program code also includes program instructions for substituting the plurality of independent variables in a regression model to calculate the total sales volume of the product. Lastly, the computer program code includes program instructions for modifying one or more independent variables of the plurality of independent variables in the regression model to obtain the base sales volume of the product. The base sales volume of the product is same as the calculated total sales volume when the base sales volume obtained after modifying the one or more independent variables is either negative or greater than the total sales volume.

### BRIEF DESCRIPTION OF THE DRAWINGS

The preferred embodiments of the invention will hereinafter be described in conjunction with the appended drawings provided to illustrate, but not to limit, the invention, wherein like designations denote like elements, and in which

FIG. 1 is a block diagram depicting sales of a product through promotional and non-promotional activities, in accordance with an embodiment of the present invention;

FIGS. 2a-b are a flowchart illustrating a method for estimating the base sales volume of the product, in accordance with an embodiment of the present invention;

FIG. 3 is a flowchart illustrating a data cleansing operation, in accordance with an embodiment of the present invention;

FIG. 4 is a flowchart illustrating a data preparation operation, in accordance with an embodiment of the present invention; and

FIG. 5 is a block diagram of a base sales volume estimator, in accordance with an embodiment of the present invention.

### DETAILED DESCRIPTION

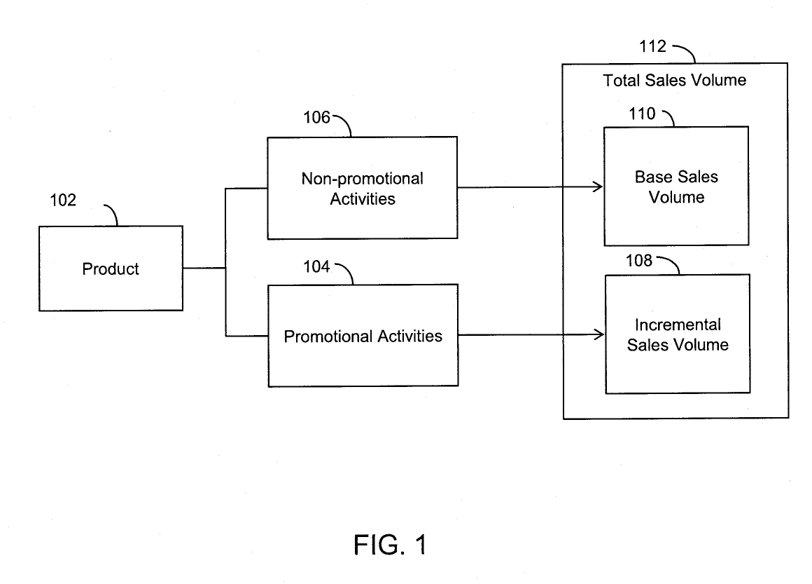

FIG. 1 illustrates a block diagram depicting sales of a product 102 through promotional activities 104 and non-promotional activities 106, in accordance with an embodiment of the present invention. Product 102 can be any product, such as an FMCG product, software, a car, and a mobile phone, sold by an organization.

Typically, organizations use various promotional activities to market their products. Examples of such promotional activities include, but are not limited to, display of pictures of their products in shops and seasonal discounts. A similar scenario is shown in FIG. 1, where product 102 is being sold using promotional activities 104. Along with promotional activities, product 102 is also sold using conventional means, i.e., using non-promotional activities 106. A typical scenario can be, for example, a car being sold for a certain discounted price at a particular location and time, and the same car being sold at the regular price at a different location and/or time.

As depicted, the sales through promotional activities 104 is termed as an incremental sales volume 108 and the sales through non-promotional activities 106 is termed as a base sales volume 110. Incremental sales volume 108 and base sales volume 110 together constitute a total sales volume 112 of product 102. The terminology as defined in the description of FIG. 1 has been used in the rest of the description of this patent application.

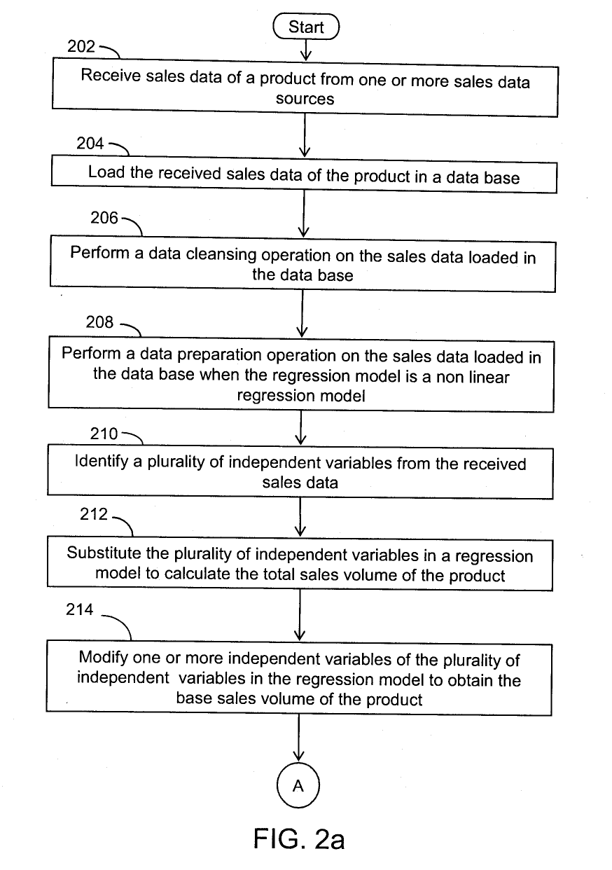

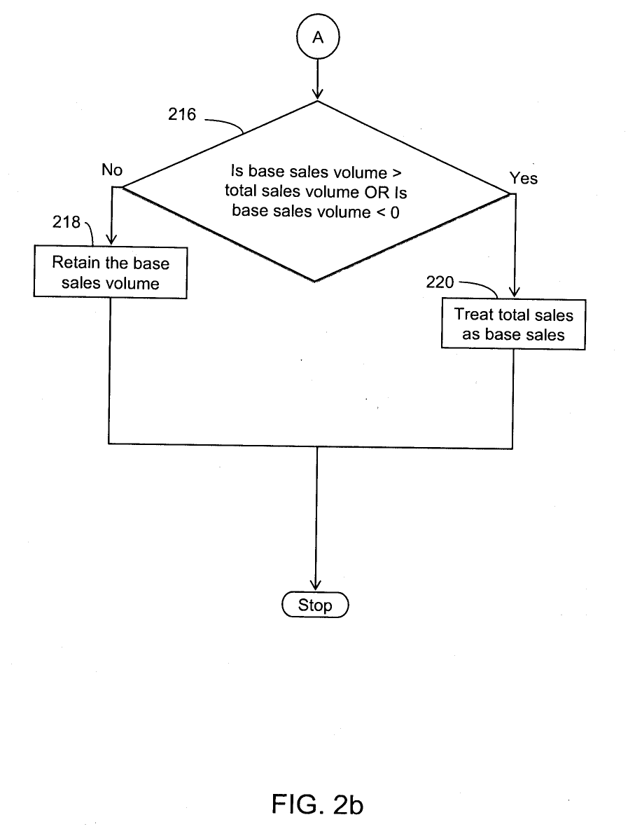

FIG. 2 is a flowchart illustrating a method for estimating base sales volume of product 102, in accordance with an embodiment of the present invention. At step 202, a sales data of product 102 is received from one or more sales data sources. The sales data sources can be, for example, data source providers such as AC Nielsen or IRI. Examples of received sales data include, but are not limited to, sales in units, sales in dollars, average retail price of the product, base price, and estimates of the extent of promotional activities measured in percentages of All Commodity Volume (ACV). Those ordinarily skilled in the art will know that the percentage of all commodity volume is a measure of sales over a group of stores.

Typically, sales data is received for a particular time period. For the sake of description in this patent application, it is assumed that the sales data is received for a period of three years or 156 weeks and micro-level data is available for a time period of one week. This is to be noted that the time period is just taken as an example, and the present invention can work efficiently with sales data for greater or lesser time periods.

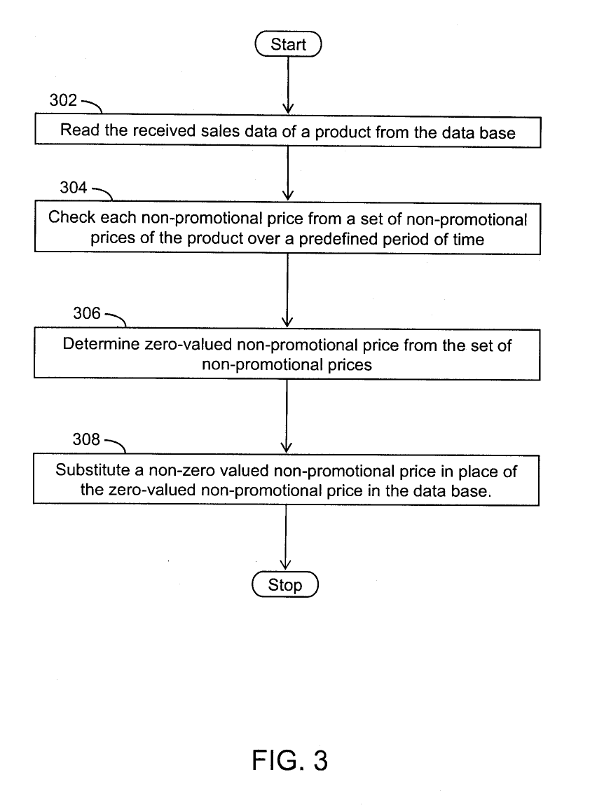

At step 204, the received sales data of product 102 is loaded or stored in a database. At step 206, a data cleansing operation is performed on the sales data stored in the database. Typically, data cleansing operation is performed to substitute any “abnormal” or “inadequate” data with a data which can be readily used to estimate the base sales volume of product 102. The data cleansing operation is described in detail in FIG. 3.

At step 208, a data preparation operation is performed on the cleansed sales data stored in the database if the regression model that is used to estimate the base sales volume of product 102 is a non-linear regression model. This concept of non-linear regression model will become clear with the help of the following explanation.

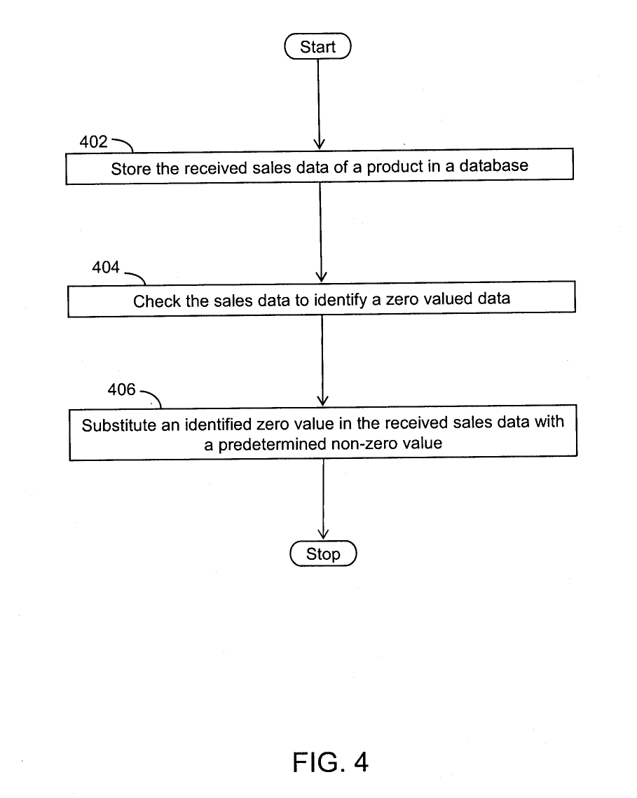

Typically, regression models are used to analyze a set of data which includes many independent and dependent variables. Regression models are of two types—a linear regression model and a non-linear regression model. The linear regression model is used where dependencies between variables are defined using linear equations. On the contrary, if a model is non-linear in the parameters, then the model is known as non-linear regression model, even if the variables in such a model are linear. In the case of the present invention, if a non-linear regression model is used to estimate the base sales volume, a data preparation operation is also performed on the data stored in the database. The entire process of using a regression model to estimate base sales volume of a product will become clear in the description of subsequent steps of FIG. 2. Also, the process of data preparation of sales data is explained in FIG. 4.

At step 210, a plurality of independent variables is identified from the received sales data to be substituted in the regression model used for estimating the base sales volume of product 102. In accordance with an embodiment of the present invention, the plurality of independent variables corresponds to sales through promotional activities 104 and a non-promotional price of product 102. Few more examples of the independent variables considered in the present invention are mentioned below. Those ordinarily skilled in the art will appreciate the invention can also work with greater number of independent variables.

As an example, one of the identified independent variable can be an average non-promotional price (NP) of product 102 calculated every week for a period of 156 weeks. Typically, the average non-promotional price of the product is the average price of the product over a predefined period of time in which the product is sold in one or more stores not involved in promotional activities 104.

The second independent variable considered in the present invention is a “Percentage of total sales through stores Not participating in any Promotional activity (PNP)”. Typically, PNP is calculated for a period of time, for example, a week, and data source providers calculate PNP based on all commodity volume (ACV). Those ordinarily skilled in the art will know that ACV is the sum total of all the commodities sold in a particular market or category. PNP is generally expressed as a percentage of ACV.

The third independent variable considered in the present invention is a “Percentage of total sales through stores participating in only in-store Display Advertisement (PDA)” of product 102. In-store display advertisement is a promotional activity that includes displaying product 102 at prominent places in a store. Similar to the last variable, this variable is also shown expressed as a percentage of ACV.

The fourth variable considered is a “Percentage of total sales through stores participating in only Feature Advertisement (PFA)” of product 102. Typically, promotion through features is run in stores by circulating information about product and promotional offer to customers in a printed hard copy. PFA is also expressed as a percentage of ACV.

The fifth and the last variables considered in the present invention is “Percentage of total sales through stores participating in both Feature and Display Advertisement (PFDA)” of product 102. As an example, if both display promotion and feature promotions are run simultaneously in a given time period at retail stores, the sales data is recorded under the head “feature and display”. The percentage of sales from such stores constitutes PFDA of product 102.

Once the values for five independent variables mentioned above are determined and the total sales volume of the product for every week for a period of 156 weeks is available, at step 212, the values are fitted in the regression model to determine the coefficients (β₀, β₁, β₃, β₄, and β₅) in the model. These coefficients are used to calculate the total sales volume (predicted) of product 102. This way, the total sales of product 102 can be calculated for any week.

As already mentioned, the present invention uses two kinds of regression models. One of the regression models is Multivariate Linear Regression (MLR) Model. This model uses the five independent variables identified in step 210. The function for this model is mentioned below:

TS=β₀+β₁×NP+β₂×PNP+β₃×PDA+β₄×PFA+β₅×PFDA

Here, TS is the total sales of product 102 and β₀, β₁, β₂, β₃, β₄, and β₅ are different coefficients. As an additional step (not shown in FIG. 2) in the process for calculating base sales volume of product 102, these six coefficients are determined before substituting the identified independent variables in the regression model. Typically, the least squares estimation method is used to determine these coefficients. For example, if total sales volume of product 102 (and the values of the some/all independent variables) is already known for some weeks of the 156 weeks, the function mentioned above can be used to determine the coefficients using the least squares estimation method. Those ordinarily skilled in the art will understand that least squares estimation method is just used as an example and the present invention can work efficiently with other methods as well.

The second kind of regression model used in the present invention is a Multivariate Non-Linear Regression (MNLR) Model. The following are examples of functions for two such models:

$$ln ( TS ) = {β}_{0} \times {NP}^{{β}_{1}} \times {PNP}^{{β}_{2}} \times {PDA}^{{β}_{3}} \times {PFA}^{{β}_{4}} \times {PFDA}^{{β}_{5}}$$

$$ln ( \frac{{TS}_{max} - TS}{TS - {TS}_{min}} ) = {β}_{0} \times {NP}^{{β}_{1}} \times {PNP}^{{β}_{2}} \times {PDA}^{{β}_{3}} \times {PFA}^{{β}_{4}} \times {PFDA}^{{β}_{5}}$$

Here, TSₘₐₓ and TSₘᵢₙ, are maximum and minimum values, respectively, among the total sales volume considered for developing the model. In accordance with an embodiment of the present invention, these values are automatically determined using a software program or a software module.

Those ordinarily skilled in the art will know that the first function mentioned above is a double-log function, and the second function is an S-shaped function. The invention can be used for other non-linear models, such as Cobb-Douglas model and semi-log model, as well.

Typically, the non-linear models are converted into linear model before they are used to estimate total sales for a particular week. For example, in the case of double-log model mentioned above, the function is converted into a linear function by taking log of the entire function, as shown below:

ln [ln(TS)]=ln(β₀)+β₁×ln(NP)+β₂×ln(PNP)+β₃×ln(PDA)+β₄×ln(PFA)+β₅×ln(PFDA)

In this function, values of the independent variables are substituted to determine the total sales of product 102 for any week by using the available 156 weeks sales data.

At step 214, one or more independent variables are modified in the regression model to obtain the base sales volume of product 102. As already mentioned, the total sales of product 102 is the sum of the base sales volume and the incremental sales volume of product 102. In accordance with an embodiment of the present invention, when a linear regression model is used to estimate the total sales of product 102, independent variables corresponding to the incremental sales are substituted as zero. For example, in the linear regression model mentioned earlier, PDA, PFA, and PFDA are substituted as zero, and the value of PNP is substituted as 100%. As a result of the substitute, the function for base sales (BS) becomes the following:

BS=β₀+β₁×NP+β₂×100+β₃×0+β₄×0+β₅×0

Similarly, for multivariate non-linear regression model, base sales volume of product 102 is estimated by substituting a small value, for example, 0.00000001, in the values for PDA, PFA, and PFDA and 100% for PNP. The reason why zero is not substituted in the non-linear regression model is that log (zero) is not defined, and hence value of base sales cannot be calculated if we use zero for the above mentioned independent variables. The resulting equation for base sales volume becomes the following:

ln [ln(BS)]=ln(β₀)+β₁×ln(NP)+β₂×ln(100)+β₃×ln(0.00000001)+β₄×ln(0.00000001)+β₅×ln(0.00000001)

The computed value is a natural log of natural log of BS. The BS is obtained by computing exponential of exponential of the resulting value (i.e., exp{exp(ln [ln(BS)])}).

At step 216, it is checked whether the computed BS is greater than the total sales volume or if the computed BS is negative. If either of these conditions is true, at step 220, the total sales volume of product 102 is treated as the base sales volume. For example, if the computed BS is 150 units and the total sales is 100 units, the base sales volume of product 102 is considered as 100 units. If, on the contrary, both the conditions are false, at step 218, the base sales estimated at step 214 is retained as base sales volume of product 102.

FIG. 3 is a flowchart illustrating a data cleansing operation, in accordance with an embodiment of the present invention. At step 302, the sales data of product 102 stored in a database is read for every week. For example, if the sales data is available for the last 156 weeks, sales data for every week of these 156 weeks is read. At step 304, the non-promotional price of product 102 is checked for each week from a set of non-promotional price of product 102 for 156 weeks. At step 306, zero-valued non-promotional prices are identified from the set of non-promotional prices for 156 weeks. At step 308, a zero-valued non-promotional price is substituted with a non-zero valued non-promotional price in the set of non-promotional prices.

In accordance with an embodiment of the present invention, for a particular week which has a zero-valued non-promotional price, a non-zero valued non-promotional price for the preceding week is determined and substituted as the non-promotional price for the particular week. For example, if week #45 has a zero-valued non-promotional price, the non-zero non-promotional price of week #44 is substituted as the non-promotional price of week #45.

The entire exercise of data cleansing is performed to make sure that there is no entry corresponding to a zero-valued non-promotional price in the sales data stored in the database.

FIG. 4 is a flowchart illustrating a data preparation operation, in accordance with an embodiment of the present invention. As already mentioned in FIG. 2, data preparation operation is performed only when the non-linear regression model is used to estimate the base sales volume of product 102.

At step 402, the sales data of product 102 received from sales data sources such as AC Nielsen or IRI is stored in a database. At step 404, the stored sales data is checked to identify any zero-valued sales data. In accordance with an embodiment of the present invention, all the sales data, except the non-promotional price, is checked for any zero-valued entry. The non-promotional price is not checked, as it is checked during the data cleansing process.

As an example, the zero-valued entry is checked corresponding to independent variables such as percentage of total sales through stores not participating in promotional activities, percentage of total sales through stores participating in only in-store display advertisement of the product, percentage of total sales through stores participating in only feature advertisement of the product, and percentage of total sales through stores participating in both feature and display advertisement of the product.

At step 406, the identified zero-valued entries are substituted with a predetermined non-zero entry. As an example, the non-zero entry can be 0.00000001 (or any other value very close to zero). The reason why zero-valued data is not preferred in the sales data is because the non-linear regression model uses logarithm function, and hence the model cannot have zero-valued inputs.

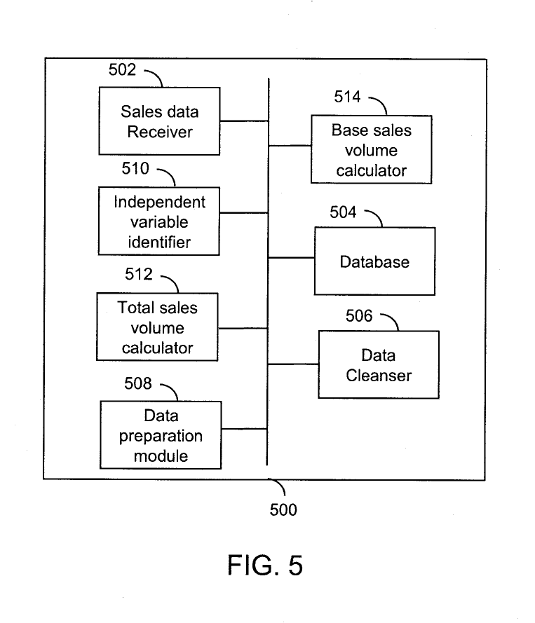

FIG. 5 is a block diagram of a base sales volume estimator 500, in accordance with an embodiment of the present invention. Base sales volume estimator 500 can be used to estimate base sales volume of product 102 sold through one or more promotional activities. As depicted, base sales volume estimator 500 includes a sales data receiver 502 for receiving sales data of product 102 from data sources such as AC Nielsen® or IRI®. Sales data is usually received for a predefined time period, for example, for the last 156 weeks.

When the sales data is received, it is stored in a database 504 and then a data cleanser 506 performs data cleansing operation on the stored sales data. The entire data cleansing operation is explained in FIG. 3. Base sales volume estimator 500 further includes a data preparation module 508, which identifies zero-valued sales data and substitutes it with a predetermined non-zero entry. Data preparation module 508 is used only when the non-linear regression model is used to estimate base sales volume of product 102. The process of data preparation has already been explained in FIG. 4.

Base sales volume estimator 500 includes an independent variable identifier 510 for identifying values of independent variables from the received sales data. In accordance with an embodiment of the present invention, the identified values are related to the average non-promotional price of product 102 and sales of product 102 through promotional activities. Few examples of the identified variables are mentioned in FIG. 2 and will not be explained here again.

Base sales volume estimator 500 also includes a total sales volume calculator 512 for substituting the identified independent variables in a regression model to calculate a total sales volume of product 102. Total sales volume calculator 512 is also configured to determine the coefficients of the regression model using least squares estimation. The process of calculating total sales of product 102, coefficients of the regression model, and examples of regression models used to estimate total sales is mentioned in FIG. 2.

Base sales volume estimator 500 includes a base sales volume calculator 514 for modifying the independent variables in the regression model to obtain the base sales volume of product 102. As already mentioned, if the obtained base sales volume of product 102 is either negative or greater than the total sales volume, the total sales volume is considered as the base sales volume of product 102. The steps involved in modifying independent variables to obtain base sales volume of a product is explained in FIG. 2.

Various embodiments of the present invention provide various advantages. Firstly, the base sales volume calculated using the present invention does not result in a negative base sales value. Secondly, complex algorithms are not required to estimate base sales using the present invention. Therefore, advanced computers are not required to run the regression models used in the present invention. Thirdly, data for all the weeks is not required to estimate base sales volume of the product. Even if some data is missing, the regression model can efficiently calculate the base sales volume of the product.

The method and the system for estimating base sales volume of a product, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as Blue ray disks, DVD, CD-ROMS, Flash chips, and floppy disks.

The set of instructions may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions can be embedded in a computer program product for use with a computer, the computer program product comprising a computer-usable medium with a computer-readable program code embodied therein. Processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for estimating the base sales volume of a product of an organization involved in one or more promotional activities, wherein the base sales volume of the product corresponds to sales of the product by non-promotional activities, the method comprising:
receiving sales data of the product from one or more sales data sources;
identifying a plurality of independent variables from the received sales data, wherein the plurality of independent variables corresponds to at least one of sales through the one or more promotional activities and an average non-promotional price of the product;
substituting the plurality of independent variables in a regression model to calculate a total sales volume of the product; and
modifying one or more independent variables of the plurality of independent variables in the regression model to obtain the base sales volume of the product;
wherein the base sales volume of the product is same as the calculated total sales volume when the base sales volume obtained after modifying the one or more independent variables is at least one of negative and greater than the total sales volume.

2. The method according to claim 1, wherein the plurality of independent variables comprises at least one of:
the average non-promotional price of the product, wherein the average non-promotional price of the product is the average price of the product over a predefined period of time in which the product is sold in one or more stores not involved in the one or more promotional activities;
a percentage of total sales through the one or more stores not participating in one or more promotional activities over the predefined period of time;
a percentage of total sales through a first set of stores participating in only in-store display advertisement of the product over the predefined period of time;
a percentage of total sales through a second set of stores participating in only feature advertisement of the product over the predefined period of time; and
a percentage of total sales through a third set of stores participating in both feature and display advertisement of the product over the predefined period of time.

3. The method according to claim 1 further comprising, determining one or more coefficients of the regression model before substituting the plurality of independent variables in the regression model.

4. The method according to claim 3, wherein the one or more coefficients are determined using least squares estimation.

5. The method according to claim 1 further comprising, before identifying the plurality of independent variables:
storing the received sales data of the product in a database;
performing a data cleansing operation on the sales data stored in the database; and
performing a data preparation operation on the sales data stored in the database when the regression model is a non-linear regression model.

6. The method according to claim 5, wherein performing the data cleansing operation comprises:
checking each non-promotional price from a set of non-promotional prices of the product over a predefined period of time, wherein the sales data comprises the set of non-promotional prices, and wherein the set of non-promotional prices comprises a non-promotional price for each week of the predefined period of time;
determining a zero-valued non-promotional price from the set of non-promotional prices;
substituting a non-zero valued non-promotional price in place of the zero-valued non-promotional price in the database.

7. The method according to claim 5, wherein performing the data preparation operation comprises:
checking a set of values to identify a zero value in the received sales data, the set of values correspond to:
a percentage of total sales through stores not participating in one or more promotional activities;
a percentage of total sales through a first set of stores participating in only in-store display advertisement of the product;
a percentage of total sales through a second set of stores participating in only feature advertisement of the product; and
a percentage of total sales through a third set of stores participating in both feature and display advertisement of the product over the predefined period of time;
wherein the set of values is determined over a predefined period of time; and
substituting an identified zero value in the received sales data with a predetermined non-zero value.

8. A base sales volume estimator for estimating a base sales volume of a product of an organization involved in one or more promotional activities, wherein the base sales volume of the product corresponds to sales of the product by non-promotional activities, the base sales volume estimator comprising:
a sales data receiver for receiving sales data of the product from one or more sales data sources;
an independent variable identifier for identifying a plurality of independent variables from the received sales data, wherein the plurality of independent variables corresponds to at least one of sales through the one or more promotional activities and an average non-promotional price of the product;
a total sales volume calculator for substituting the plurality of independent variables in a regression model to calculate a total sales volume of the product; and
a base sales volume calculator for modifying one or more independent variables of the plurality of independent variables in the regression model to obtain the base sales volume of the product;
wherein the base sales volume of the product is same as the calculated total sales volume when the base sales volume obtained after modifying the one or more independent variables is at least one of negative and greater than the total sales volume.

9. The base sales volume estimator according to claim 8, wherein the plurality of independent variables comprises at least one of:
the average non-promotional price of the product, wherein the average non-promotion price of the product is the average price over a predefined period of time in which the product is sold in one or more stores not involved in the one or more promotional activities;
a percentage of total sales through the one or more stores not involved in the one or more promotional activities over the predefined period of time;
a percentage of total sales through a first set of stores participating in only in-store display advertisement of the product over the predefined period of time;
a percentage of total sales through a second set of stores participating in only feature advertisement of the product over the predefined period of time; and
a percentage of total sales through a third set of stores participating in both feature and display advertisement of the product over the predefined period of time.

10. The base sales volume estimator according to claim 8, wherein the total sales volume calculator is further configured to determine one or more coefficients of the regression model before substituting the plurality of independent variables in the regression model.

11. The base sales volume estimator according to claim 10, wherein the total sales volume calculator determines the one or more coefficients using least squares estimation.

12. The base sales volume estimator according to claim 8 further comprising:
a database for storing the received sales data of the product;
a data cleanser for performing a data cleansing operation on the sales data stored in the database before identifying the plurality of independent variables; and
a data preparation module for performing a data preparation operation on the sales data stored in the database when the regression model is a non-linear regression model

13. The base sales volume estimator according to claim 12, wherein the data cleanser performs the data cleansing operation by:
checking each non-promotional price from a set of the non-promotional prices of the product over a predefined period of time, wherein the sales data comprises the set of the non-promotional prices, and wherein the set of the non-promotional prices comprises the non-promotional price for each week of the predefined period of time;
determining a zero-valued non-promotional price from the set of the non-promotional prices; and
substituting a non-zero valued non-promotional price in place of the zero-valued non-promotional price in the database.

14. The base sales volume estimator according to claim 12, wherein the data preparation module performs the data preparation operation by:
checking a set of values to identify a zero value in the received sales data, the set of values correspond to:
a percentage of total sales through stores not participating in one or more promotional activities;
a percentage of total sales through a first set of stores participating in only in-store display advertisement of the product;
a percentage of total sales through a second set of stores participating in only feature advertisement of the product; and
a percentage of total sales through a third set of stores participating in both feature and display advertisement of the product over the predefined period of time;
wherein the set of values is determined over a predefined period of time; and
substituting an identified zero value in the received sales data with a predetermined non-zero value.

15. A computer program product for use with a computer, the computer program product comprising a computer usable medium having a computer readable program code embodied therein for estimating a base sales volume of a product of an organization involved in one or more promotional activities, wherein the base sales volume of the product corresponds to sales of the product by non-promotional activities, the computer program code comprising:
program instructions for receiving sales data of the product from one or more sales data sources;
program instructions for identifying a plurality of independent variables from the received sales data, wherein the plurality of independent variables corresponds to at least one of sales through the one or more promotional activities and an average non-promotional price of the product;
program instructions for substituting the plurality of independent variables in a regression model to calculate a total sales volume of the product; and
program instructions for modifying one or more independent variables of the plurality of independent variables in the regression model to obtain the base sales volume of the product;
wherein the base sales volume of the product is same as the calculated total sales volume when the base sales volume obtained after modifying the one or more independent variables is at least one of negative and greater than the total sales volume.

16. The computer program product according to claim 15, wherein the plurality of independent variables comprises at least one of:
the average non-promotional price of the product, wherein the average non-promotional price of the product is the average price of the product over a predefined period of time in which the product is sold in one or more stores not involved in the promotional activities;
a percentage of the total sales through the one or more stores not involved in the one or more promotional activities over the predefined period of time;
a percentage of the total sales through a first set of stores participating in only in-store display advertisement of the product over the predefined period of time;
a percentage of the total sales through a second set of stores participating in only feature advertisement of the product over the predefined period of time; and
a percentage of the total sales through a third set of stores participating in both feature and display advertisement of the product over the predefined period of time.

17. The computer program product according to claim 15 further comprising program instructions for determining one or more coefficients of the multivariate regression model before substituting the plurality of independent variables in the regression model.

18. The computer program product according to claim 17, wherein the one or more coefficients are determined using least squares estimation.

19. The computer program product according to claim 15 further comprising:
program instructions for storing the received sales data of the product in a database;
program instructions for performing a data cleansing operation on the sales data stored in the database before identifying the plurality of independent variables; and
program instructions for performing a data preparation operation on the sales data stored in the database when the regression model is a non-linear regression model.

20. The computer program product according to claim 19, wherein program instructions for performing the data cleansing operation comprises:
program instructions for checking each non-promotional price from a set of non-promotional prices of the product over a predefined period of time, wherein the sales data comprises the set of non-promotional prices, and wherein the set of non-promotional prices comprises the non-promotional price for each week of the predefined period of time;
program instructions for determining a zero-valued non-promotional price from the set of non-promotional prices; and
program instructions for substituting a non-zero valued non-promotional price in place of the zero-valued non-promotional price in the database.

21. The computer program product according to claim 19, wherein the program instructions for performing the data preparation operation comprises:
program instructions for checking a set of values to identify a zero value in the received sales data, the set of values correspond to:
a percentage of total sales through stores not participating in one or more promotional activities;
a percentage of total sales through a first set of stores participating in only in-store display advertisement of the product;
a percentage of total sales through a second set of stores participating in only feature advertisement of the product; and
a percentage of total sales through a third set of stores participating in both feature and display advertisement of the product over the predefined period of time;
wherein the set of values is determined over a predefined period of time; and
program instructions for substituting an identified zero value in the received sales data with a predetermined non-zero value.
